(19) United States
(12) Patent Application Publication
(10) Pub. No.: US 2025/0322309 A1
(43) Pub. Date: Oct. 16, 2025

(54) LIVE WORKSHEETS ARTIFICIAL INTELLIGENCE

(71) Applicant: 2hr Learning, Inc., Austin, TX (US)

(72) Inventors: Arpan Gupta, Chandigarh (IN); Sahil Marwaha, Mumbai (IN); Vicky Biswas, Kehradun (IN)

(73) Assignee: 2hr Learning, Inc., Austin, TX (US)

(21) Appl. No.: 19/177,489

(22) Filed: Apr. 11, 2025

Related U.S. Application Data
(60) Provisional application No. 63/633,009, filed on Apr. 11, 2024.

(51) Int. Cl. G06N 20/00; G09B 7/02; G09B 7/06

(52) U.S. Cl. CPC G06N 20/00; G09B 7/02; G09B 7/06

(57) ABSTRACT

An assessment generation platform communicates with an artificial intelligence (AI) assessment generation system for generation of an assessment based on inputs provided by a user. The AI-based assessment generation system is configured to receive a natural language assessment generation request data from the assessment generation platform. The natural language assessment generation request data includes one or more details related to one or more questions to be included in the requested assessment. The received natural language request data is then processed by the AI-based assessment generation system using an artificial intelligence system having a natural language processing engine that includes a language model and machine learning algorithms. During the one or more question generation process, the AI-based assessment generation system also accesses a curriculum database including curriculum data for one or more educational standards to align the generated one or more questions with the educational standards.

### CROSS-REFERENCE TO RELATED APPLICATION

This application claims the benefit under 35 U.S.C. § 119(e) and 37 C.F.R. § 1.78 of U.S. Provisional Application No. 63/633,009, filed Apr. 11, 2024, which is incorporated by reference in its entirety.

### FIELD OF THE INVENTION

The present invention relates in general to the field of electronics, and more specifically to integrate natural language processing (NLP) and large language models (LLMs) with an AI-based assessment generation system to automate the creation, delivery, and grading of assessment in real-time based on the user inputs.

### BACKGROUND OF THE INVENTION

The demand for effective assessment tools has increased significantly over the years. A digital assessment platform revolutionizes the way educators evaluate student learning. The digital assessment platform provides intuitive interfaces, customizable features, and seamless integration of multimedia content, from quizzes and exams to interactive assignments. The digital assessment platforms empower educators to engage students in meaningful ways while providing invaluable insights into their progress. As schools continue to embrace technology-enhanced learning environments, these platforms emerge as a tool for facilitating personalized learning experiences and driving academic excellence into the digital age. With the help of the digital assessment platform, students can complete assessments remotely at their convenience, and educators can assess them to provide feedback in real-time.

While using conventional assessment platforms, educators have relied on their knowledge and the resources available to them on the platform to design assessments. While some assessment platforms have provided question banks or templates, however, while utilizing the said platform the educators still require manual selection and assembly of the questions. Moreover, aligning questions within the competence level of the students often involves manual efforts of educators. Also, educators refer to various education standards and content databases to design assessments that align with the competence level of the students. Such methods are manually exhaustive, provide inconsistent output, and error-prone due to the complexity and constantly evolving nature of education standards. The use of content databases often resulted in a lack of specificity and relevance to the specific needs of individual students. On the other hand, manual alignment of assessments to students is time-consuming. While using the conventional assessment platforms the educators may need to wait for a significant amount of time before incorporating specific feedback. This lack of adaptability can result in a less efficient process of assessments, which may not be able to meet the specific requirements of educators in different contexts.

### SUMMARY

One or more embodiment of a method include:
providing a user interface to integrate communication between an assessment generation platform and an artificial intelligence (AI) based assessment generation system to:
   receive an assessment generation request from a user via the user interface of the assessment generation platform;
   transmit the assessment generation request to the AI-based assessment generation system, wherein the AI-based assessment generation system includes an artificial intelligence system having a natural language processing engine that includes a language model and machine learning algorithms;
receiving, with the AI-based assessment generation system, the assessment generation request from the assessment generation platform, wherein the assessment generation request includes a natural language request data including details related to a topic, format, and complexity of questions to be included in the requested assessment;
processing the received assessment generation request by the AI-based assessment generation system comprises:
   accessing a curriculum database including curriculum data for one or more educational standards, wherein the curriculum data includes a plurality of topics and detailed content of individual topics;
   matching the received assessment generation request data to the curriculum data to identify a matching topic in the curriculum data;
   generating one or more questions related to the selected topic, wherein the AI-based assessment generation system utilizes natural language processing techniques and machine learning algorithm to generate one or more questions for the assessment;
   validating the generated one or more questions to ensure relevance and accuracy of the generated one or more questions;
   compiling the validated one or more questions to generate an assessment including one or more questions aligned to the assessment generation request data; and
   displaying the generated assessment to a user via the user interface of the assessment generation platform.

One or more embodiment of a system include:
one or more processors; and
a memory, coupled to the one or more processors, that includes code that when executed causes the one or more processors to perform operations comprising:
   providing a user interface to integrate communication between an assessment generation platform and an artificial intelligence (AI) based assessment generation system (AI-based assessment generation system) to:
   receive an assessment generation request from a user via the user interface of the assessment generation platform;
   transmit the assessment generation request to the AI-based assessment generation system, wherein the AI-based assessment generation system includes an artificial intelligence system having a natural language processing engine that includes a language model and machine learning algorithms;
   receiving, with the AI-based assessment generation system, the assessment generation request from the assessment generation platform, wherein the assessment generation request includes a natural language request data including details related to a topic, format, and complexity of questions to be included in the requested assessment;
   processing the received assessment generation request by the AI-based assessment generation system comprises:
   accessing a curriculum database including curriculum data for one or more educational standards, wherein the curriculum data includes a plurality of topics and detailed content of individual topics;
   matching the received assessment generation request data to the curriculum data to identify a matching topic in the curriculum data;
   generating one or more questions related to the selected topic, wherein the AI-based assessment generation system utilizes natural language processing techniques and machine learning algorithm to generate one or more questions for the assessment;
   validating the generated one or more questions to ensure relevance and accuracy of the generated one or more questions;
   compiling the validated one or more questions to generate an assessment including one or more questions aligned to the assessment generation request data; and
   displaying the generated assessment to a user via the user interface of the assessment generation platform.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary assessment generation platform and AI-based assessment generation system in an environment.

FIG. 2 depicts an exemplary assessment generation process using the assessment generation platform and the AI-based assessment generation system of FIG. 1.

FIG. 3 depicts a flow diagram to validate the generated questions using a large language models (LLMs).

FIGS. 4-9 depict exemplary user interface displays for allowing interaction between the user and the assessment generation platform.

FIG. 10 depicts an exemplary network environment in which the system of FIG. 1 and the process of FIG. 2 may be practiced.

FIG. 11 depicts an exemplary computer system.

### DETAILED DESCRIPTION

An assessment generation platform communicates with an artificial intelligence (AI) assessment generation system for generation of an assessment based on inputs provided by a user. The AI-based assessment generation system is configured to receive a natural language assessment generation request data from the assessment generation platform. The natural language assessment generation request data includes one or more details related to one or more questions to be included in the requested assessment. The received natural language request data is then processed by the AI-based assessment generation system using an artificial intelligence system having a natural language processing engine that includes a language model and machine learning algorithms. During the one or more question generation process, the AI-based assessment generation system also accesses a curriculum database including curriculum data for one or more educational standards to align the generated one or more questions with the educational standards. The access to the curriculum database is provided through the API endpoints of the curriculum database. The API endpoints allow the AI-based assessment generation system to communicate with and retrieve information from the curriculum database.

The AI-based assessment generation system leverages the artificial intelligence system having a natural language processing engine that includes a language model and machine learning algorithms to automate the creation, delivery, and grading of assessments. The use of AI system by the AI-based assessment generation system to generate and validate one or more questions simplifies the assessment creation process, reduces the time and effort required by the user, and ensures the quality and relevance of the questions. The incorporation of the curriculum data into the AI-based assessment generation system ensures that the questions are aligned with the curriculum and are relevant for the learners. The use of the curriculum data also ensures that the assessments are of high quality and are relevant to the educational needs of learners. The AI-based assessment generation system is capable of adapting in real-time based on the user inputs allowing for immediate customization and tailoring of content to specific educational needs.

The AI-based assessment generation system also facilitates the user in creating practice exams and quizzes to evaluate the knowledge and readiness of the learner. Moreover, the AI-based assessment generation system offers tools for the user to assess and understand student performance and knowledge gaps. Additionally, the AI-based assessment generation system generates and validates assessments that are customized to the learning objectives of a course. The AI-based assessment generation system is designed as a pipeline of processes, each focusing on a specific task, running on a distributed system in the cloud. This design allows for efficient handling of tasks, scalability, and robustness, ensuring that the AI-based assessment generation system can serve many users simultaneously while maintaining high performance. Each process, from generation to the validation checks, is handled by a separate system component, ensuring optimal load balancing, scalability, and resource utilization.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

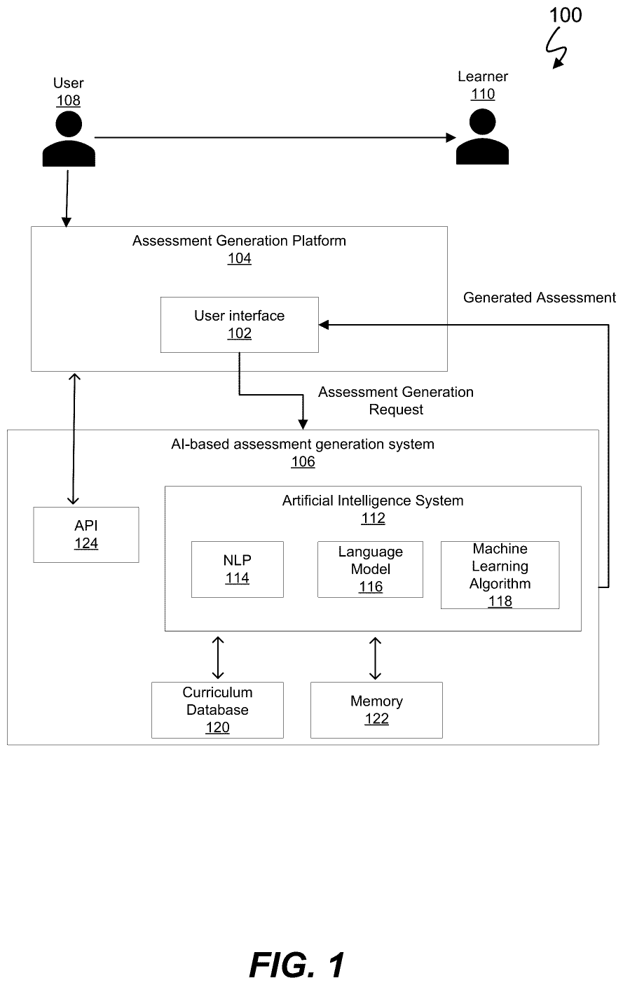

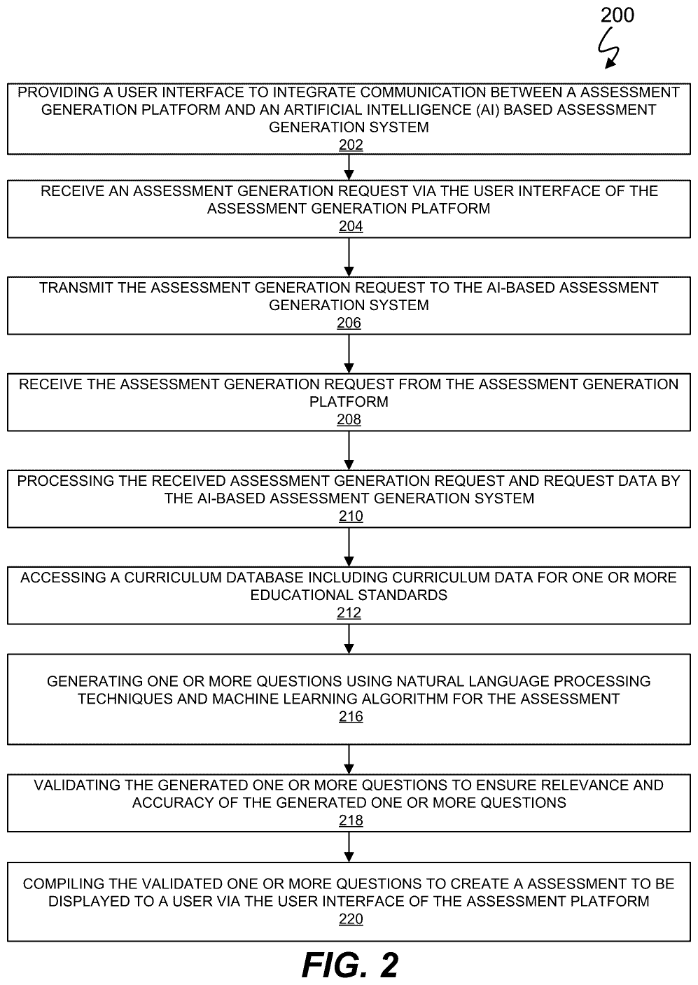

FIG. 1 depicts an exemplary AI-based assessment generation environment 100 to transform input information into generated assessments by a user using an assessment generation platform 104. FIG. 2 depicts an exemplary assessment generation process 200 utilized by the assessment generation environment 100.

Referring to FIGS. 1 and 2, in operation 202 a user interface 102 is provided a user 108 for generating an assessment via an assessment generation platform 104. The user interface 102 integrates communication between the assessment generation platform 104 and an artificial intelligence (AI) based assessment generation system (AI-based assessment generation system) 106. The assessment generation platform 104 serves as a digital environment provided to the user 108 to generate and share assessments with a learner 110 (or group of learners). The generated assessments are used as a tool to assess learning experience of the learner 110. The learner 110 is a person who is attempting the assessment and the user 108 can be teacher, tutor, instructor, or coach who is generating and assessing the assessment once submitted by the learner 110. In one embodiment, the assessment is in the form of a digital test paper including one or more questions. The assessment allows the user 108 to identify how well the learner 110 is learning various educational concepts or topics. Moreover, the assessment helps in improving the learning ability of the learner 110 along with improving teaching styles adopted by the user 108. The assessment generation platform 104 provides a flexible platform to the user 108, allowing generation of assessments and delivery of the generated assessments to the learner 110 catering to different schedules and preferences of the learner 110. The AI-based assessment generation system 106 is a back-end system that leverages artificial intelligence (AI) to automate the creation, delivery, and grading of the assessments in real time.

The AI-based assessment generation system 106 enhances the efficiency, accessibility, and effectiveness of assessments by transitioning assessments to digital environments, by allowing the learner 110 to complete assessments remotely at their convenience. The AI-based assessment generation system 106 ensures smooth data exchange, streamlined workflows, and enhanced user experience.

The user 108 logs into the assessment generation platform 104 through a user device. The user device includes a computer, desktop, mobile device or any other device that is capable of using the internet and can access the assessment generation platform 104. Upon authentication, the user 108 can log in to the assessment generation platform 104. Typically, the authentication requires the user 108 to provide login credentials, for example, username and password, via the user interface 102 of the assessment generation platform 104. Upon authentication, the assessment generation platform 104 establishes a connection with the assessment generation system 106.

The user interface 102 serves as a gateway for the user 108 to initiate assessment creation processes. The user interface 102 is designed in a way to allow user 108 to easily prepare the assessment and is easily accessible to the learner 110. In addition, the user interface 102 also ensures that the user 108 can navigate the assessment generation platform 104 with ease.

In operation 204, the user 108 provides assessment generation requests via the user interface 102 of the assessment generation platform 104. The assessment generation request is the process of initiating creation of an assessment. The assessment generation request includes specific criteria or learning objectives that the assessment should cover, as well as any preferred formats or methodologies. In one embodiment, the assessment generation request includes a natural language request data including details related to a topic, format, and complexity of one or more questions to be included in the requested assessment. The user 108 selects the topic that allows creation of questions related to any particular subject and topic included therein. The user further selects the format including types of questions to be included in the assessment, where the types of questions include multiple choice questions, true or false, description questions, and fill in the blanks. The user 108 provides input related to the complexity of one or more questions by selecting a grade level (or grade) of the learner (or group of learners) so that the questions included in the assessment aligns to the competence level of the learner 110 as per the grade he/she is in.

Once the assessment generation request is made, AI-based assessment generation system 106 is responsible for developing the assessment that aligns with the goals of the learner 110. The assessment generation request provides a means of gauging the understanding or proficiency of learner 110 in a particular subject or field corresponding to the generated assessment, enabling decision-making regarding the progress of the learner 110.

In operation 206, the AI-based assessment generation system 106 receives the assessment generation request, wherein the AI-based assessment generation system 106 includes an artificial intelligence system 112 having a natural language processing engine 114 that includes a language model 116 and machine learning algorithms 118. The AI-based assessment generation system 106 uses the artificial intelligence (AI) system 112 to receive and process assessment generation request. The AI system 112 includes language models and machine learning algorithms. The AI system 112 understands and interprets the submitted assessment generation request using the natural language processing engine 114. Moreover, the machine learning algorithms 118 enable the AI system 112 to improve its performance. The AI system 112 extracts key information from the assessment generation request to leverage the repository to provide an appropriate assessment. For example, if the assessment generation request include multiple-choice questions as the format for generation of an assessment related to a specific topic in mathematics, the AI system 112 generates a set of multiple choice questions that accurately assess the learner's 110 comprehension of that topic.

In operation 208, the AI-based assessment generation system 106 receives the assessment generation request from the assessment generation platform 104, wherein the assessment generation request includes a natural language request data including details related to a topic, format, and complexity of questions to be included in the requested assessment. The natural language request data serves as a parameter that defines the scope of the assessment to be generated, thereby enabling generation of personalized and adaptive assessments matching to the unique needs and preferences of the learner 110. The “topic” determines the specific subtopics, and learning units to be covered within the assessment. By incorporating topics, the AI-based assessment generation system 106 can deliver assessments that are aligned with the specific topic of the subject to the learner 110. The natural language request data enables targeted assessment that addresses specific learning objectives, competencies, or instructional priorities. Additionally, the “format” allows the user 108 to select from the variety of questions to be included in the assessment, such as multiple-choice, fill in the blanks, true or false, and description questions. The format enables the AI-based assessment generation system 106 to offer diverse and engaging assessment experiences that cater to different learning styles, cognitive processes, and assessment objectives. The natural language request data also includes complexity of questions. The complexity provides a level of difficulty or intricacy involved in understanding, interpreting, or processing questions within the assessment. The AI-based assessment generation system 106 encompasses various factors such as the depth of subject matter, the language and vocabulary used.

In at least one embodiment, the natural language request data includes “subject” which indicates the academic discipline or domain for which the assessment is conducted, such as mathematics, science, language arts, or social studies. This natural language request data ensures that assessment content is aligned with the specific knowledge areas and learning objectives relevant to the academics of the learner 110. Additionally, the natural language request data includes the “grade” specifying the educational level of the learner 110. The grade helps the AI-based assessment generation system 106 in identifying the exact class of learner 110 in which he is studying. The grade ensures that the content of the assessment is aligned with the curriculum standard of the learner 110. This allows the AI-based assessment generation system 106 to adjust the complexity, and scope of assessment to match the skill level of the learner 110. Furthermore, the natural language request data includes the “number of questions” specifying the quantity or volume of questions in the assessment presented to the learner 110. The number of questions allows flexibility in assessment length, duration, and depth of coverage. The AI-based assessment generation system 106 utilizes the natural language request data to develop the assessment that is practical and beneficial for the learner 110 to tailor the specific requirements and learning objective.

The below is data structure corresponding to the natural language request data provided by the user on the assessment generation platform:

```
{
  “grade”: “9”,
  “subject”: “Science”,
  “topic”: “Cell Transport”
}
question_schema = {
    “question_type”: {
      “type”: “enum”,
      “values”: [“mcq”, “fib”, “tof”, “descriptive”]
    },
    “question”: “string”,
    “answer”: {
      “type”: “union”,
      “values”: [“string”, [“string”]]
    },
    “options”: [
      {“type”: “string”}
    ]
}
```

In operation 210, the AI-based assessment generation system 106 processes the received assessment generation request and natural language request data. When the AI-based assessment generation system 106 system receives the assessment generation request and natural language request data from the user 108, it analyzes the natural language input by using AI algorithms, the AI-based assessment generation system 106 parses the request to understand its meaning, identifying key components such as the subject matter, the type of assessment needed (e.g., quiz, test), and any specific requirements or preferences indicated by the user 108. Then, the AI-based assessment generation system 106 uses pre-existing assessment templates to generate a customized assessment tailored to the user's request. This involves selecting relevant questions, adjusting difficulty levels if necessary, and coherently organizing the content. Moreover, the AI-based assessment generation system 106 may also employ machine learning techniques to improve understanding of user's request, thereby enhancing its ability to generate high-quality assessments.

In operation 212, the AI-based assessment generation system 106 accesses a curriculum database 120 including curriculum data for one or more educational standards, wherein the curriculum data includes a plurality of topics and detailed content of individual topics. AI-based assessment generation system 106 relies on the curriculum database 120 containing structured information about one or more educational standards. The one or more educational standards are the board of education, school committee or school board that determines the educational policy in a city, county, state, or province. Typically, the curriculum database 120 includes the plurality of topics and detailed content of individual topics. The curriculum database 120 is a detailed listing of the topics that the learner 110 are expected to learn at different grade levels. For example, the topic selected by user 108 is math, the curriculum database 120 categorizes math into various topics like algebra, geometry, and calculus. Under each of these topics, there would be subtopics and a detailed breakdown of concepts and skills that the learner 110 should acquire at each grade level. This plurality of topics and detailed content of individual topics enables the AI-based assessment generation system 106 to create assessments that align with the grade level of the learner 110, ensuring that the questions are relevant, appropriate in difficulty, and cover the necessary content areas. By leveraging the curriculum data, the AI-based assessment generation system 106 can efficiently generate assessments that accurately reflect the educational standards and learning objectives that support effective teaching and learning processes. In at least one embodiment, the curriculum data incorporates a comprehensive set of tools and utilities for managing and updating educational standards and educational standards requirements, ensuring that the generated assessment remains aligned with the latest guidelines and regulations. The curriculum data within the curriculum database 120 automatically retrieves and synchronizes updates to educational standards, enabling timely adjustments to the generated assessment as needed.

Typically, matching the received assessment generation request data to the curriculum data to identify a matching topic in the curriculum data involves using natural language processing techniques to analyze the topic details provided in the assessment generation request data and extracting key terms that are relevant to the topic. Then, these extracted key terms are compared to the numerous topics and detailed content stored in the curriculum data. Next, the AI-based assessment generation system 106 identifies one or more topics from the curriculum data that closely align with the topic details from the request data. Finally, the identified topics are ranked based on their similarity to the assessment generation request data, with topics closely matching the request data receiving higher rankings compared to those that are less related. This ensures efficient and accurate retrieval of curriculum topics.

In operation 214, the AI-based assessment generation system 106 matches the received assessment generation request data to the curriculum data, wherein matching the request data to the curriculum data identifies the selected topic and content related to that topic that is to be utilized for the generation of the requested assessment. The AI-based assessment generation system 106 compares the assessment generation request data to the information stored within the curriculum data. The AI-based assessment generation system 106 aims to identify the relevant topics and corresponding content from the curriculum data that align with the assessment generation request. The AI-based assessment generation system 106 analyzes the assessment generation request data by extracting key parameters such as a topic, format, and complexity of content to be included in the requested assessment. Then the AI-based assessment generation system refers to the curriculum database, which contains detailed information about the topics and content covered in the educational standards for that topic and grade level. The curriculum data is aligned to one or more educational standards including Common Core State Standards (CCSS), Next Generation Science Standards (NGSS), College Board, and so on which houses comprehensive details of each topic included in these curriculum. The AI-based assessment generation system 106 matches the parameters of the assessment generation request data to the corresponding entries in the curriculum database. This matching process involves identifying the selected topic or topics relevant to the assessment and retrieving the associated content outlined within the curriculum data. For example, if the assessment request pertains to a math assessment for eighth-grade students focusing on geometry, the AI-based assessment generation system 106 would locate the geometry topic within the curriculum database 120 for eighth grade and extract the specific concepts and skills related to geometry that the learner 110 are expected to learn at that level. The AI-based assessment generation system 106 is configured to align the assessment generation request with the curriculum data, the AI-based assessment generation system 106 ensures that the generated assessment reflects the educational standards and learning objectives appropriate for the intended grade level and subject area. In this regard, the AI-based assessment generation system 106 ensures that the assessment is tailored to the educational needs of the learner 110 and covers the essential topic.

In operation 216, the AI-based assessment generation system 106 generates one or more questions based on the content related to the selected topic, wherein the AI-based assessment generation system utilizes natural language processing techniques and machine learning algorithms to generate one or more questions for the assessment. Once the AI-based assessment generation system 106 has identified the specific topic or topics relevant to the assessment from the curriculum database, it proceeds to create one or more questions associated with those topics. The AI-based assessment generation system 106 employs natural language processing techniques and machine learning algorithms to analyze and comprehend the content related to the selected topic. The AI-based assessment generation system 106 parse through the curriculum database to extract key information and identify the concepts, and skills that are pertinent to the assessment. The natural language processing techniques allow the AI-based assessment generation system 106 to understand the context and meaning of the content related to the selected topic, to formulate the one or more questions for the assessment. Additionally, the AI-based assessment generation system 106 utilizes machine learning algorithms to generate one or more questions that are diverse, relevant, and appropriate in difficulty level. The machine learning algorithms utilize the curriculum data to align the one or more questions with educational standards. Furthermore, the AI-based assessment generation system 106 incorporates additional criteria specified by the user, such as format such as multiple-choice, fill in the blanks, true or false, and description questions to generate the one or more questions for the assessment.

The AI-based assessment generation system 106 interprets the natural language request data for ensuring that the generated one or more questions align with the natural language request data of the user 108 thereby facilitating meaningful assessment. In generating questions, the natural language processing techniques and machine learning algorithm may employ a variety of strategies and methodologies to ensure the relevance of the one or more questions. For example, the natural language processing techniques and machine learning algorithm may utilize paraphrasing techniques to generate questions that are linguistically distinct from the previous question while retaining the core concepts.

In operation 218, the AI-based assessment generation system 106 validates the generated one or more questions to ensure relevance and accuracy of the generated one or more questions. After the one or more questions have been generated based on the selected topic and content, the AI-based assessment generation system 106 employs various validation techniques to assess their quality. The AI-based assessment generation system 106 verifies the completeness of the one or more questions by ensuring they cover all relevant aspects of the selected topic. This involves checking whether the questions address the key concepts, skills, and knowledge outlined in the curriculum database 120 for that topic. The AI-based assessment generation system 106 also evaluates the diversity of the questions to ensure they encompass a range of cognitive levels. The AI-based assessment generation system 106 assesses the accuracy of the generated one or more questions to confirm that they provide correct information and assess the intended learning outcomes accurately. To assess the accuracy of the generated one or more questions, the AI-based assessment generation system 106 involves cross-referencing the questions with the curriculum database. The AI-based assessment generation system 106 updates one or more questions failed in the validation process.

In at least one embodiment, the AI-based assessment generation system 106 may involve evaluating the clarity and readability of the generated one or more questions to ensure they are easily understandable by the learner 110. This includes assessing factors such as language complexity, ambiguity, and formatting to optimize the clarity and accessibility of the one or more questions for the learner 110. The AI-based assessment generation system strives to produce assessments that meet the standards and objectives of the educational curriculum while providing valuable insights into the knowledge and skills of the learner 110. The AI-based assessment generation system 106 involves a series of linguistic analyses and computational operations designed to assess the quality and coherence of the generated one or more questions and align the questions based on the natural language request data provided by the user 108. The AI-based assessment generation system 106 examines various aspects of the one or more questions, including consistency with the natural language request data, correctness, difficulty level, inconsistencies, ambiguities, or errors that may detract from clarity or effectiveness.

In at least one embodiment, the AI-based assessment generation system 106 can generate alternative questions, providing the user 108 with a range of options to consider while preparing the assessment. The AI-based assessment generation system 106 serves as a powerful tool for enhancing the learning experience by generating one or more questions that are tailored to the natural language request data provided by the user 108. The AI-based assessment generation system 106 employs an AI engine, specifically Claude 3 Opus developed by Anthropic, to generate assessments including one or more questions. The AI-based assessment generation system 106 operates by analyzing the assessment generation request data and leveraging Claude 3 Opus's capabilities to generate one or more questions aligned to the assessment generation request data.

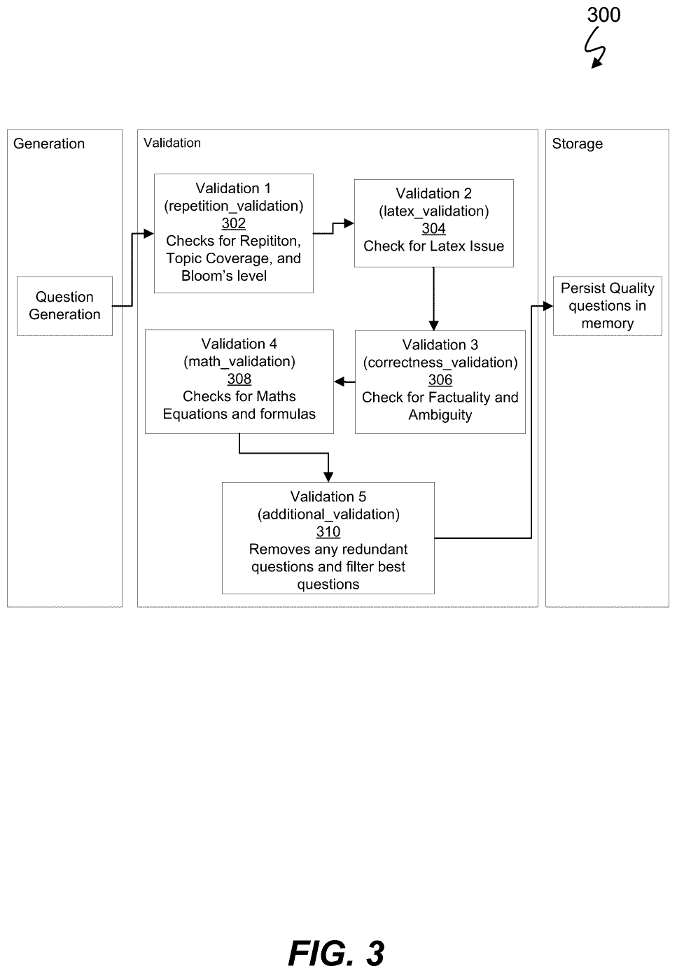

FIG. 3 is a flow diagram 300 depicting steps involved in validation of the generated one or more questions using LLM 116 of the AI-based assessment generation system 106 (as shown in FIG. 1). The one or more generated assessment questions are shared with the language model 116 for validation. The AI-based assessment generation system 106 use multiple validation functions to validate the generated one or more questions. In one embodiment, five validation functions are used for validation of assessment questions. The validation functions include repetition_validation 302, latex_validation 304, correctness_validation 306, math_validation 308, and additional_validation 310. The repetition_validation 302 is a function used to ensure that the generated one or more questions are not repeated within the assessment. The repetition_validation 302 helps maintain integrity and prevents duplication of one or more questions that could lead to errors or inconsistencies. The repetition_validation 302 checks for repetition, topic coverage, and bloom's level. The bloom's level is a classification of the different outcomes and skills that the user 108 set for the learner 110. The bloom's level includes six levels such as remembering, understanding, applying, analyzing, evaluating, and creating. The latex_validation 304 is a function that ensuring adherence of generated one or more questions to the syntax rules. The latex_validation 304 allows checking the structure, formatting and errors of the generated one or more questions to identify and correct inconsistencies. The correctness_validation 306 is a function ensuring that the generated one or more questions meet requirements or standards to produce expected outcomes under various conditions. The math_validation 308 is a function of verifying the accuracy, correctness, and integrity of mathematical calculations, algorithms, models, formulas or data of the generated one or more questions. The math_validation 308 ensures that mathematical operations are performed correctly and produce valid results according to established rules, principles, and standards. After validation, the one or more questions are updated to ensure correctness and relevancy of the final set of questions to be included in the assessment. The final set of questions are then stored in a memory 122.

The validation of the generated one or more questions further comprises executing one or more validation codes using an artificial intelligence (AI) engine to ensure adherence of generate questions with one or more critical aspects such as repetition, topic coverage, clarity of instructions, correctness of questions and answers, language sensitivity, relevance, adherence to education framework, and correctness of LaTeX and Tikz codes and math equations. The validation codes evaluate various dimensions including repetition, ensuring that questions are sufficiently varied to prevent redundancy and maintain engagement. Additionally, the assessment's topic coverage is observed to generate a comprehensive relevant subject matter. The clarity of instructions is assessed to ensure that the learner 110 can effectively comprehend and respond to the questions. Moreover, correctness of both questions and answers is verified to maintain the accuracy and integrity of the assessment content. The accuracy of LaTeX and Tikz codes, alongside mathematical equations, is verified by the AI engine to ensure seamless presentation and comprehension of mathematical content. The AI engine ensures that the resulting assessments are not only accurate and comprehensive but also engaging and aligned with the education framework.

The below is data structure for repetition_validation, latex_validation, correctness_validation, and math_validation performed by the AI-based assessment generation system 106:

```
import large_language_model as llm
import llm_based_math_checker as math_checker
def get_standard_descriptions(subject, grade, topic):
  common_core_data = get_common_core_data( )
  descriptions = common_core_data.get_descriptions(subject, grade, topic)
def repetition_validation(assessment):
```

| | | |
|---|---|---|
| if | llm.repetition_detected(assessment) | or |

```
llm. blooms_levels_not_covered(assessment):
    return llm.update_assessment(assessment)
  return assessment
def latex_validation(assessment):
  if llm.invalid_latex_detected(assessment):
    return llm.update_assessment(assessment)
  return assessment
def correctness_validation(assessment):
  for question in assessment:
    if llm.is_incorrect(question):
      question = 1lm.update_question(question)
  return assessment
def math_validation(assessment):
  for question in assessment:
    if math_checker.is_incorrect(question):
      question = math_checker.update_question(question)
  return assessment
def pick_best_questions(assessment, num_questions_to_pick):
  trimmed_assessment = llm.pick_best_questions(assessment)
  return assessment
def generate_assessment(subject, grade, topic, num_mcq, num_fib, num_tof,
num_descriptive, use_cache):
  topic_details = get_standard_descriptions(subject, grade, topic)
  cached_questions = get_cached_questions(subject, grade, topic)
  if use_cache and cached_questions. exist(num_mcq, num_fib, num_tof,
num_descriptive):
    return cached_questions
  mcq_questions = llm.generate_mcq_questions(num_mcq+buffer_questions)
  fib_questions = llm.generate_fib_questions(num_fib+buffer_questions)
  tof_questions = llm.generate_tof_questions(num_tof+buffer_questions)
```

| | |
|---|---|
| descriptive_questions | = |

llm.generate_descriptive_questions(num_descriptive+buffer_questions)

| | |
|---|---|
| assessment = | create_assessment(mcq_questions, fib_questions, |

```
tof_questions, descriptive_questions)
  updated_assessment = repetition_validation(assessment)
  updated_assessment = latex_validation(updated_assessment)
  updated_assessment = correctness_validation(updated_assessment)
  if subject == “Math”:
    updated_assessment = math_validation(updated_assessment)
  updated_assessment = pick_best_questions(updated_assessment)
  return updated_assessment
```

In operation 220, the one or more questions that have been validated by the AI-based assessment generation system 106 are compiled to create the assessment that is ready for display to the user 108. The AI-based assessment generation system 106 is configured to organize the validated one or more questions in a sequence that aligns with the intended objectives and format of the assessment. For example, the system may group questions by topic or subtopic, organize them according to their difficulty level, or distribute them evenly across different question formats. In at least one embodiment, the AI engine used for validation is ChatGPT by OpenAI. The AI-based assessment generation system 106 takes into account various factors, including the distribution of question types, the difficulty level of questions, the sequencing of the one or more questions, and the overall length and timing of the assessment, to create assessments that are engaging for the learner 110. Additionally, the AI-based assessment generation system 106 can generate multiple versions of assessments to mitigate the risk of cheating and enhance the reliability of assessment results. Furthermore, the AI-based assessment generation system 106 can integrate with existing educational platforms, and assessment tools, facilitating seamless integration of existing educational platforms.

Once the assessment is compiled and formatted, the AI-based assessment generation system 106 displays the assessment to the user 102 on the user interface 102 of the assessment platform. The user interface 102 serves as the gateway through which the user 103 interacts with the AI-based assessment generation system 106. The user interface 102 empowers the learner 110 to actively engage with assessment content, monitor their progress, and receive timely guidance and support as required. Moreover, the user interface 102 is designed to be responsive and adaptable across a wide range of user devices and screen sizes, ensuring a consistent and seamless user experience.

The below is a prompt to guide and constrain the AI engine to display the generate the assessment based on the user input on the user interface of the artificial intelligence system:

```
{
  “input”: {
          “grade”: “9”,
          “subject”: “Science”,
          “difficulty_level”: “Hard”,
          “topics”: [
        {
    “standard_descriptions”: {
      “Level1”: “Cells depend on the structure of the cell membrane to move
materials into and out of the cell in order to maintain dynamic homeostasis. a.
Passive transport involves the movement of solutes across the membrane along
the concentration gradient, without the use of additional energy. b. Active
transport involves the movement of solutes across the membrane against their
concentration gradients with the use of additional energy. c. Bulk transport of
molecules across the membrane is accomplished using endocytosis or exocytosis.”
    },
    “learning_objectives”: [
      “Use data to investigate how various solutes and/or solvents passively move
across membranes.”,
      “Explain how materials move into or out of the cell across the cell
membrane.”,
      “Create and/or use representations and/or models to predict the movement
of solutes into or out of the cell.”
    ],
    “key_concepts”: [ ]
        }
          ],
          “topic_name”: “Cell Transport”,
          “cluster”: “Cell Transport”
  },
  “validated_questions”: [
          {
        “type”: “mcq”,
        “question”: “Which of the following correctly describes the process of
passive transport across a cell membrane?”,
        “answer”: “2”,
        “options”: [
    “The movement of molecules from areas of low concentration to areas of high
concentration without the input of energy”,
    “The movement of molecules from areas of high concentration to areas of low
concentration without the input of energy”,
    “The movement of large particles into a cell through vesicles, which is a
form of active transport”,
    “The movement of molecules against their concentration gradient using ATP,
which is a form of active transport”
        ]
          },
          {
        “type”: “mcq”,
        “question”: “Bulk transport of large molecules through a cell membrane
can be accomplished by:”,
        “answer”: “4”,
        “options”: [
    “Diffusion”,
    “Osmosis”,
    “Exocytosis”,
    “Endocytosis and Exocytosis”
        ]
          },
          {
        “type”: “mcq”,
        “question”: “Which of the following processes does NOT require energy
input?”,
        “answer”: “3”,
        “options”: [
    “Active transport”,
    “Endocytosis”,
    “Diffusion”,
    “Exocytosis”
        ]
          },
          {
        “type”: “mcq”,
        “question”: “If the concentration of sodium ions (Na+) inside a cell is
lower than the concentration outside, which of the following processes would
most likely increase the concentration of sodium ions inside the cell?”,
        “answer”: “2”,
        ”options“: [
    “Active transport using ATP”,
    “Diffusion down the concentration gradient”,
    “Endocytosis of sodium ions”,
    “Exocytosis of sodium ions”
        ]
          },
          {
        “type”: “fib”,
        “question”: “The movement of water molecules across a selectively
permeable membrane from an area of higher water concentration to an area of
lower water concentration is called _BLANK _. ”,
        “answer”: [
    “osmosis”
        ]
          },
    {
        “type”: “fib”,
        “question”: “The sodium-potassium pump is an example of _BLANK_ because
it moves sodium and potassium ions across the cell membrane against their
concentration gradients using energy from ATP.”,
        “answer”: [
    “active transport”
        ]
          },
          {
        “type”: “fib”,
        “question”: “In exocytosis, vesicles containing molecules fuse with the
_BLANK_ and release their contents outside the cell.”,
        “answer”: [
    “cell membrane”
        ]
          },
          {
        “type”: “fib”,
        “question”: “The transport of large particles like proteins into the
cell via vesicles is called _BLANK_.”
        “answer”: [
    “endocytosis”
        ]
          },
          {
        “type”: “tof”,
        “question”: “During active transport, a cell uses ATP to pump ions from
low to high concentration.”
        “answer”: “true”
          },
          {
        “type”: “tof”,
        “question”: “Exocytosis is the process by which a cell secretes large
molecules by packaging them into vesicles that fuse with the plasma membrane.”,
        “answer”: “true”
          },
          {
        “type”: “tof”,
        “question”: “The structure of the phospholipid bilayer prevents the free
passage of ions across the membrane.”,
        “answer”: “true”
          },
          {
        “type”: “tof”,
        “question”: “During endocytosis, a cell engulfs extracellular fluid and
particles by infolding its plasma membrane.”,
        “answer”: “true”
          },
          {
        “type”: “descriptive”,
        “question”: “Explain how passive transport allows solutes to move across
the cell membrane along a concentration gradient without the need for additional
energy.”
          },
          {
        “type”: “descriptive”,
        “question”: “Describe the process of active transport and explain how it
differs from passive transport in terms of solute movement and energy
requirements.”
          },
          {
        “type”: “descriptive”,
        “question”: “Explain how endocytosis and exocytosis allow for the
transport of large quantities of materials across the cell membrane.”
          },
          {
        “type”: “descriptive”,
        “question”: “Describe how the structure of the cell membrane facilitates
passive transport of solutes.”
          }
  ],
  “metadata”: {
          “grade”: “9”,
          “subject”: “Science”,
          “topic”: “Cell Transport”,
          “topicID”: “CELLS 3.2”,
          “teacher_id”: “arpan.gupta+teacher@trilogy.com”,
          “created_at”: “2024-01-16 15:01:36”,
          “token”: “36e8ee07-ef90-43a3-af9c-e2df85778b0e”,
          “use_cache”: “true”
  },
  “number_of_questions”: {
          “fib”: 4,
          “tof”: 4,
          “mcq”: 4,
          “descriptive”: 4
  },
  “token”: “36e8ee07-ef90-43a3-af9c-e2df85778b0e”
}
```

In at least one embodiment, the user interface 102 is built using React by Meta and community and is configured to display generated assessment by the AI-based assessment generation system 106 in a clear and visually appealing format. The user interface 102 may also support formatting options such as bold, italic, or underline text. Furthermore, the user interface 102 allows the user 108 to scroll through previous assessment, view the scores received on the previous assessment, or access additional resources directly from the user interface 102, enhancing the usability and convenience of the assessment generation platform 104.

In at least one embodiment, the AI-based assessment generation system 106 comprises the memory 122 for storing one or more data including-natural language request data, one or more generated questions, one or more validated questions, curriculum data, and one or more final generated assessments. The memory 122 may also include responses submitted by the learner 110, correct answers, user's information, learner's information, and learner's scores corresponding to the attempted assessments. The data is stored in a structured format within the memory 122. The AI-based assessment generation system 106 maintains a centralized repository of generated assessments for easy access, retrieval, and reuse of assessment content. Furthermore, the memory 122 ensures the confidentiality of the stored data by employing encryption techniques, access controls, and data backup procedures to safeguard sensitive information and mitigate the risk of unauthorized access or data loss. Furthermore, the memory 122 employs data backup procedures as a proactive measure to mitigate the risk of data loss and ensure data resilience. In the event of a system failure, data corruption, or accidental deletion, these backup copies can be readily accessed and restored, ensuring the continuity of operations of the assessment generation system 106.

In at least one embodiment, the assessment generation platform 104 retrieves one or more past assessment questions, relevant to a selected topic, that are stored in the memory 122 coupled to the AI-based assessment generation system 106. The user 108 accesses the past assessment questions stored in the memory 122 via the user interface 102. The past assessment questions are the questions generated by the AI-based assessment generation system 106 and are already being used in the one of assessments provided to the learner 110. The AI-based assessment generation system 106 allows the user 108 to browse, search, and retrieve one or more questions generated in the past assessments. The AI-based assessment generation system 106 allows the user 108 to quickly locate questions that align with the natural language request data provided by the user 108, thereby reducing the time and effort associated with question selection and assembly. Additionally, the user 108 can preview questions via the user interface 102, allowing them to assess the relevance of the past assessment questions before incorporating them into anew assessment. The user 108 can leverage the user interface 102 to create, edit, and format one or more questions of the generated assessment according to the preferences and requirements.

In at least one embodiment, the assessment generation platform 104 initiates communication between the assessment generation platform 104 and the AI-based assessment generation system 106 via one or more endpoints including API 124 of the assessment generation platform 104 that enable the connection between the assessment generation platform 104 with the AI-based assessment generation system 106. The API 124 enables the assessment generation platform 104 to interact with the AI-based assessment generation system 106 to provide bidirectional communication therebetween. Typically, the API 124 is utilized to send the natural language request data associated with the user 108 from the assessment generation platform 104 to the AI-based assessment generation system 106. Furthermore, the API 124 facilitates the integration of the assessment generation platform 104 with external systems and services, enabling a wide range of use cases and workflows. For example, educational institutions can integrate the assessment generation platform 104 with their learning management systems allowing seamless synchronization of assessment data and learner 110 records between the two systems.

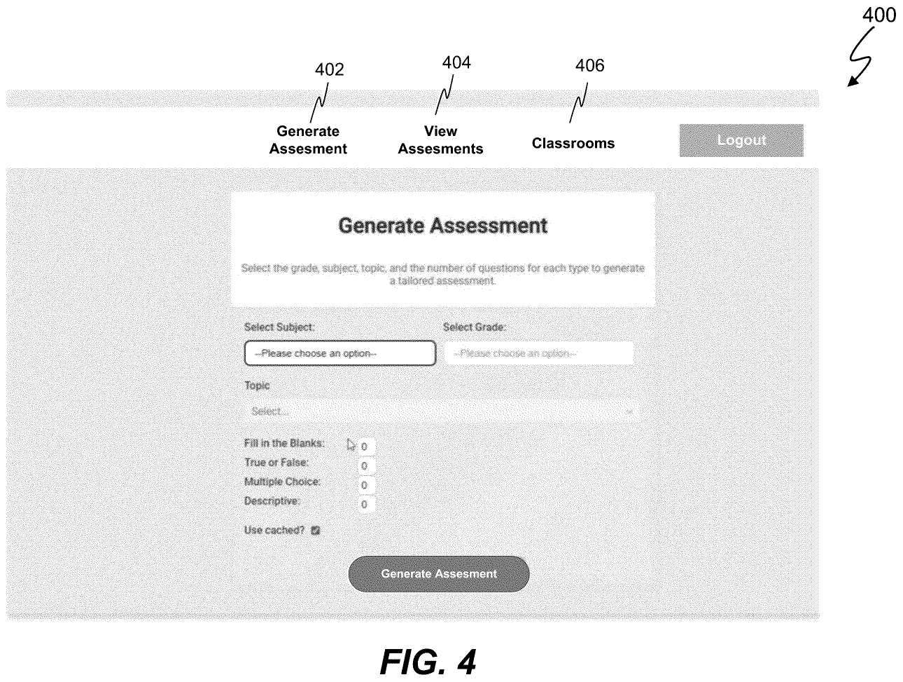

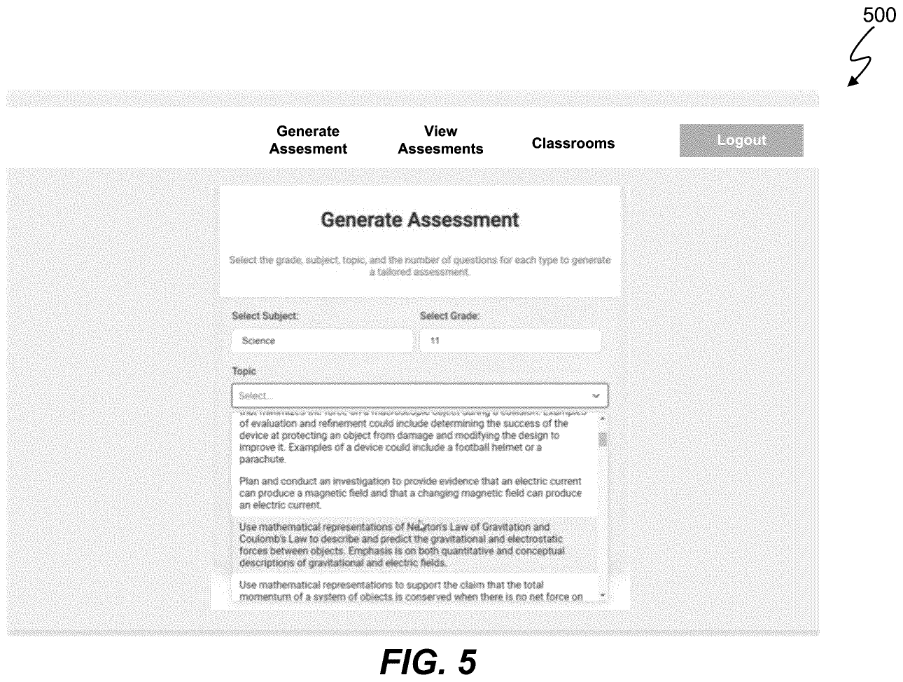

Referring to FIGS. 4-9, exemplary user interfaces 400, 500, 600, 700, 800, 900 depicting interaction between the user 108 and the assessment generation platform 104 are shown. Referring to FIG. 4, the user 108 logged in to the assessment generation platform 104 to generate the assessment. As shown in FIG. 4, the user interface 400 displays a generate assessment tab 402, view assessment tab 404 and classroom tab 406. The generate assessment tab 402 allows the user 108 to generate the new assessment. The view assessment tab 404 allows the user 108 to view all the previously generated assessments. The classroom tab 406 displays all the classes for which the user 108 is preparing the assessments and further will share the generated assessment. After clicking on the generate assessment tab 402, the user interface 400 is configured to ask the user 108 to provide the natural language request data. The natural language request data includes details related to a topic, format, and complexity of questions to be included in the requested assessment. The user interface 400 asks the user 108 to select a subject, select a grade, select a topic, select the type of question, number of questions of each type. Referring to FIG. 5, the user 108, selects “science” as the subject, and “11” as the grade. After selecting the subject and grade, the user interface 500 displays the topics. The user 108 selects the topic from the displayed topic to generate the assessment corresponding to the selected topic. Typically, the topics are the various chapters or subchapters from the selected subject corresponding to the selected grade. The user interface 500 displays a number of topics to choose from.

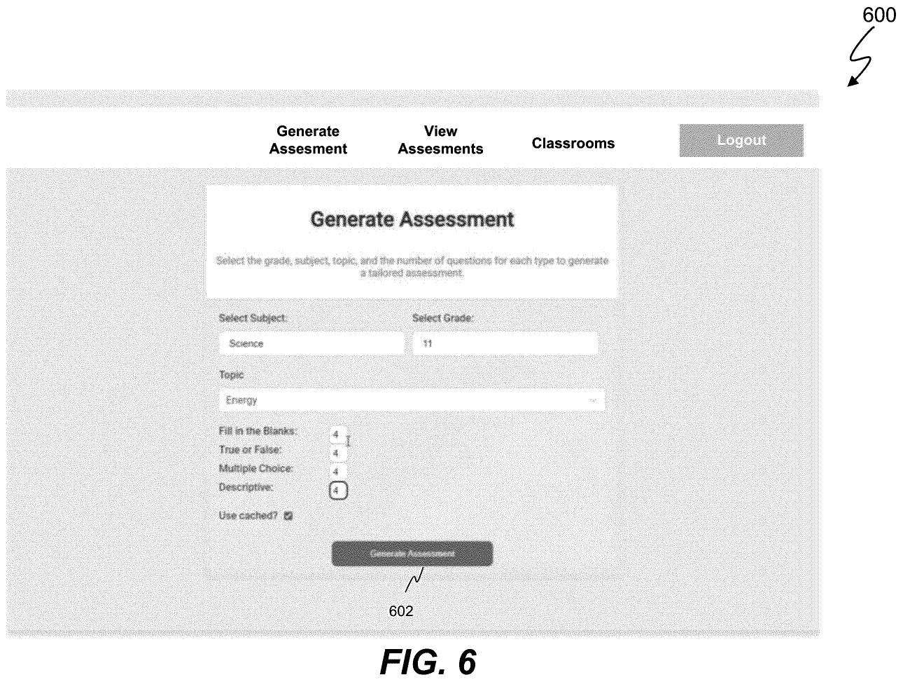

Referring to FIG. 6, the user 108, after selecting the topic “energy”, presents an option to select types of questions to be included in the assessment. The types of questions can be fill in the blanks, true or false, multiple choice and descriptive questions. The user interface 600 also allows the user 108 to select number of questions to be generated for each type of question. The user 108 provides the number corresponding to each type of question. Once all the information is provided to the assessment generation platform 104, the AI-based assessment generation system 106 asks the user to click on the generate assessment tab 602 to generate the assessment.

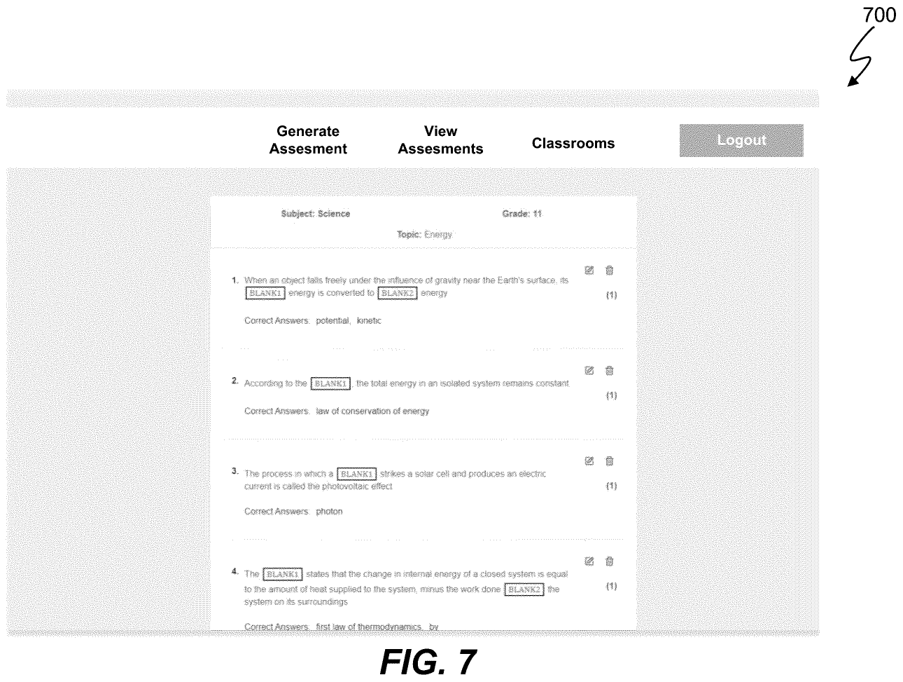

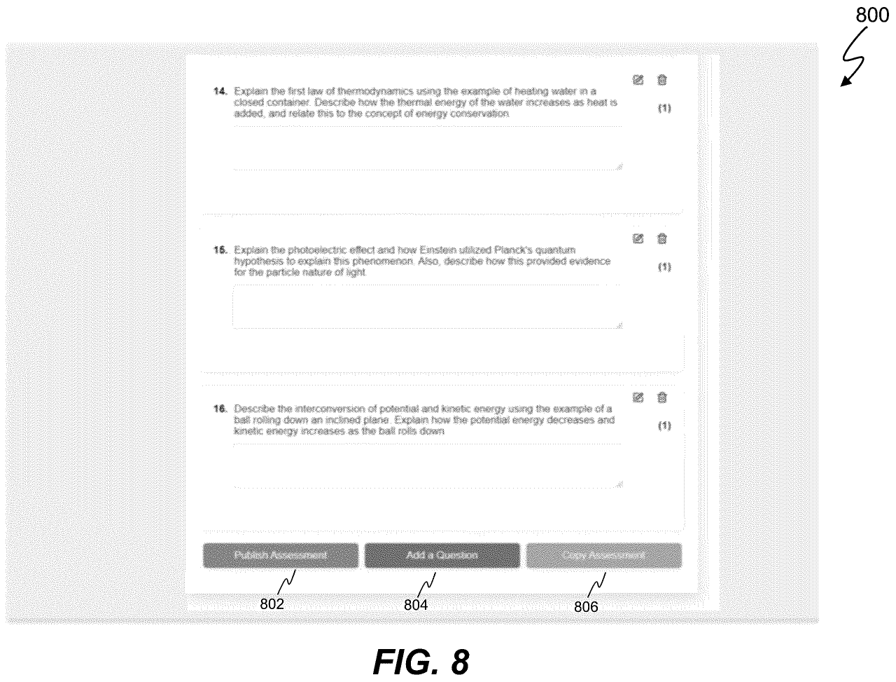

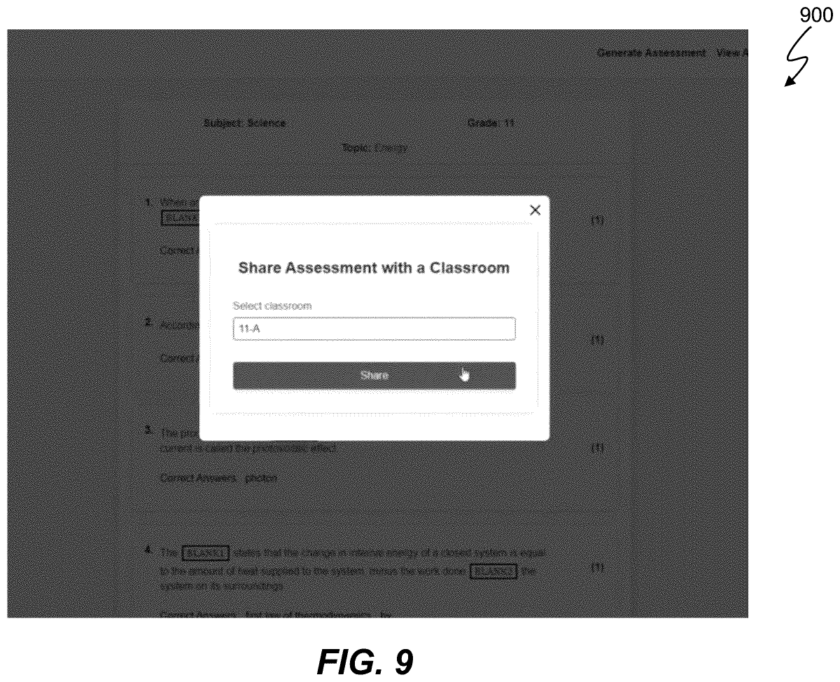

Referring to FIG. 7 and FIG. 8, the user interface 700, 800 shows the generated assessment to the user 108. As shown in FIG. 7, the user interface 700 is configured to display the one or more questions and the correct answer of the question to the user 108. The displayed correct answer allows the user 108 to verify the generated assessment. The user 108 can edit or delete the generated one or more questions. The user 108 uses the assessment generation platform 104 to delete questions from the generated assessment if the user 108 identifies the generated question as unrelated. As shown, the user 108 is allowed to delete, edit, or add one or more new questions in the generated assessment, via the user interface 700 of the assessment generation platform 104, to generate a final assessment as per his preferences if the user 108 identifies the inaccuracy in the generated question. The user interface 700, also displays the subject, grade and topic as selected by the user 108. As shown in FIG. 8, the assessment generation platform 104 displays the 16 questions as selected by the user 108. The user interface 800 displays a publish assessment tab 802, add a question 804, and copy assessment tab 806. The publish assessment tab 802 allows the user 108 to publish the generated assessment. The add a question 804 allows the user to add a new question in the generated assessment. The copy assessment tab 806 allows the user 108 to copy the generated assessment. Referring to FIG. 9, the user interface 900 shows the user 108 to share the generated assessment to a classroom. The classroom is the designated setting where the user 108 shares the generated assessment with the learner 110. The user 108 may have multiple classrooms where he teaches. The assessment generation platform 104 allows the user 108 to select from multiple classrooms to share the generated assessment.

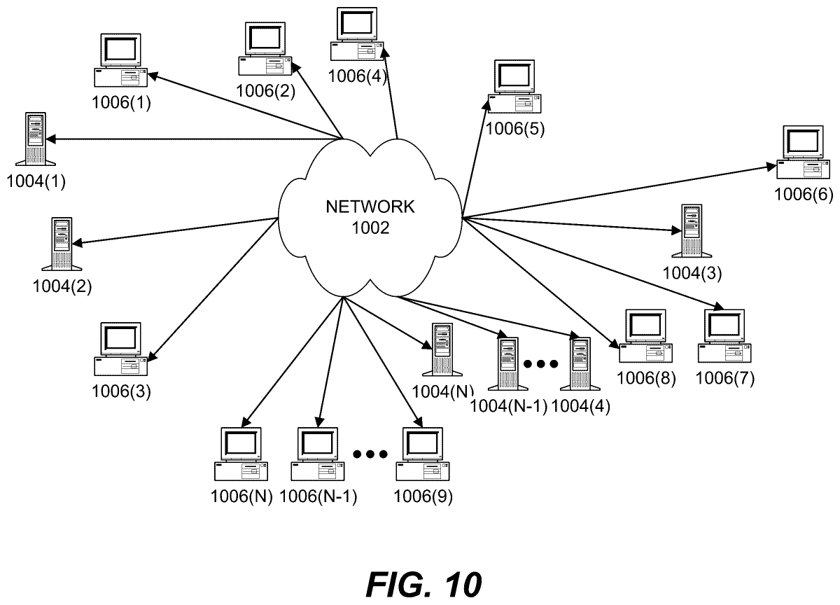

FIG. 10 is a block diagram illustrating a network environment in which an assessment generation environment 100 and assessment generation process 200 may be practiced. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

Client computer systems 1006(1)-(N) and/or server computer systems 1004(1)-(N) are specialized computer programmed to improve conventional computer systems to implement and utilize the assessment generation environment 100 and assessment generation process 200. The type of computer system that can be specially programmed to implement and utilize the assessment generation environment 100 and assessment generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the assessment generation environment 100 and assessment generation process 200 can be implemented using code stored in a tangible, non-transient computer readable medium and executed by one or more processors. In at least one embodiment, the assessment generation environment 100 and assessment generation process 200 can be implemented completely in hardware using, for example, logic circuits and other circuits including field programmable gate arrays.

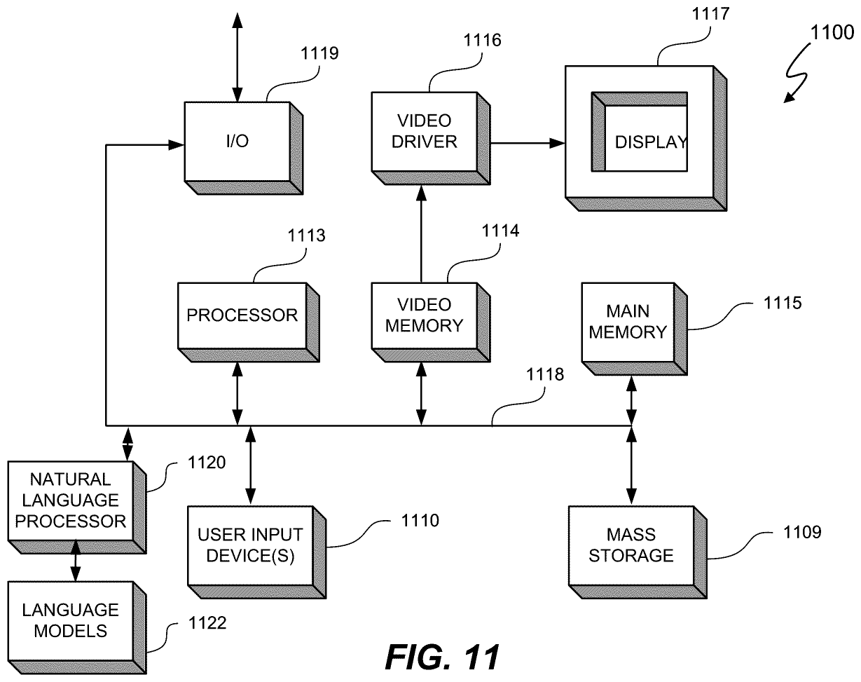

Embodiments of the assessment generation environment 100 and assessment generation process 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 1113. The mass storage 1109 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1109, main memory 1115, video memory 1114 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1109, into main memory 1115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1014 is coupled to video amplifier 1116. The video amplifier 1116 is used to drive the display 1017. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The assessment generation environment 100 and assessment generation process 200 may be implemented in any type of computer system or programming or processing environment. It is contemplated that the assessment generation environment 100 and assessment generation process 200 might be run on a stand-alone computer system, such as the one described above. The assessment generation environment 100 and assessment generation process 200 might also be run from a server computer systems system that can be accessed by a plurality of client computer systems interconnected over an intranet network. Finally, the assessment generation environment 100 and assessment generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims

What is claimed is:

1. A method comprising:
providing a user interface to integrate communication between an assessment generation platform and an artificial intelligence (AI) based assessment generation system to:
receive an assessment generation request from a user via the user interface of the assessment generation platform;
transmit the assessment generation request to the AI-based assessment generation system, wherein the AI-based assessment generation system includes an artificial intelligence system having a natural language processing engine that includes a language model and machine learning algorithms;
receiving, with the AI-based assessment generation system, the assessment generation request from the assessment generation platform, wherein the assessment generation request includes a natural language request data including details related to a topic, format, and complexity of questions to be included in the requested assessment;
processing the received assessment generation request by the AI-based assessment generation system comprises:
accessing a curriculum database including curriculum data for one or more educational standards, wherein the curriculum data includes a plurality of topics and detailed content of individual topics;
matching the received assessment generation request data to the curriculum data to identify a matching topic in the curriculum data;
generating one or more questions related to the selected topic, wherein the AI-based assessment generation system utilizes natural language processing techniques and machine learning algorithm to generate one or more questions for the assessment;
validating the generated one or more questions to ensure relevance and accuracy of the generated one or more questions;
compiling the validated one or more questions to generate an assessment including one or more questions aligned to the assessment generation request data; and
displaying the generated assessment to a user via the user interface of the assessment generation platform.

2. The method of claim 1 wherein accessing a curriculum database including curriculum data for one or more educational standards comprises:
requesting access to the curriculum database through the API endpoints of the database.

3. The method of claim 1 wherein the curriculum data is aligned to one or more educational standards including Common Core State Standards (CCSS), Next Generation Science Standards (NGSS), and College Board.

4. The method of claim 1 wherein matching the received assessment generation request data to the curriculum data to identify a matching topic in the curriculum data comprises:
analyzing the topic details included in the request data using natural language processing techniques to extract key terms relevant to the topic;
comparing the extracted key terms to the plurality of topics and detailed content of individual topics included in the curriculum data;
identifying one or more topics in the curriculum data that closely matches to the topic details of the request data; and
ranking the one or more topics in the curriculum data such that a topic that closely matches to the topic details included in request data is ranked higher as compared to a less related topic.

5. The method of claim 1 wherein the method uses an AI engine to generate an assessment including one or more questions aligned to the assessment generation request data, wherein the AI engine is Claude 3 Opus by Anthropic.

6. The method of claim 1 wherein validating the generated one or more questions further comprises:
executing one or more validation codes using an artificial intelligence (AI) engine to ensure adherence of generate questions with one or more critical aspects such as repetition, topic coverage, clarity of instructions, correctness of questions and answers, language sensitivity, relevance, adherence to education framework, and correctness of LaTeX and Tikz codes and math equations.

7. The method of claim 6 wherein the AI engine used for validation is ChatGPT by OpenAI.

8. The method of claim 1 wherein validating the generated one or more questions further comprises:
use of one or more validation functions including repetition_validation, latex_validation, correctness_validation, and math_validation.

9. The method of claim 1 wherein displaying the generated assessment to the user via the user interface of the assessment generation platform comprises:
allowing the user to delete, edit, or add one or more new questions in the generated assessment, via the user interface of the assessment generation platform, to generate a final assessment as per his preferences.

10. The method of claim 1 wherein receiving the assessment generation request from the assessment generation platform comprises:
providing a user interface to the user, on the assessment generation platform, to select:
a subject and at least one topic included in the subject; and
grade level of an end-user who will be taking the generated assessment;

11. The method of claim 1 wherein receiving the assessment generation request from the assessment generation platform comprises:
selecting the format including types of questions to be included in the assessment, wherein the types of questions include multiple choice questions, true or false, description questions, and fill in the blanks.

12. The method of claim 1 wherein generating one or more questions related to the selected topic further comprises:
retrieving one or more questions generated in the past assessments that are relevant to the selected topic, wherein the past assessments along with the questions are stored in a memory coupled to the assessment generation system.

13. A system comprising:
one or more processors; and
a memory, coupled to the one or more processors, that includes code that when executed causes the one or more processors to perform operations comprising:
providing a user interface to integrate communication between an assessment generation platform and an artificial intelligence (AI) based assessment generation system (AI-based assessment generation system) to:
receive an assessment generation request from a user via the user interface of the assessment generation platform;
transmit the assessment generation request to the AI-based assessment generation system, wherein the AI-based assessment generation system includes an artificial intelligence system having a natural language processing engine that includes a language model and machine learning algorithms;
receiving, with the AI-based assessment generation system, the assessment generation request from the assessment generation platform, wherein the assessment generation request includes a natural language request data including details related to a topic, format, and complexity of questions to be included in the requested assessment;
processing the received assessment generation request by the AI-based assessment generation system comprises:
accessing a curriculum database including curriculum data for one or more educational standards, wherein the curriculum data includes a plurality of topics and detailed content of individual topics;
matching the received assessment generation request data to the curriculum data to identify a matching topic in the curriculum data;
generating one or more questions related to the selected topic, wherein the AI-based assessment generation system utilizes natural language processing techniques and machine learning algorithm to generate one or more questions for the assessment;
validating the generated one or more questions to ensure relevance and accuracy of the generated one or more questions;
compiling the validated one or more questions to generate an assessment including one or more questions aligned to the assessment generation request data; and
displaying the generated assessment to a user via the user interface of the assessment generation platform.

14. The system of claim 13 wherein when the code is executed the code causes the one or more processor to perform further operations comprising:
validating the generated one or more questions to ensure adherence of generated questions with one or more critical aspects such as repetition, topic coverage, clarity of instructions, correctness of questions and answers, language sensitivity, relevance, adherence to education framework, and correctness of LaTeX and Tikz codes and math equations.

15. The system of claim 13 wherein validating the generated one or more questions further comprises:
use of one or more validation functions including repetition_validation, latex_validation, correctness_validation, and math_validation.

16. The system of claim 13 wherein validating the generated one or more questions further comprises:
updating one or more questions failed in the validation process, wherein updating includes generation of new questions using a machine learning model accessed by the one or more processors.

17. The system of claim 13 wherein displaying the generated assessment to the user via the user interface of the assessment generation platform comprises:
allowing the user to delete, edit, or add one or more new questions in the generated assessment, via the user interface of the assessment generation platform, to generate a final assessment as per his preferences.

18. The system of claim 13 wherein matching the received assessment generation request data to the curriculum data to identify a matching topic in the curriculum data comprises:
analyzing the topic details included in the request data using natural language processing techniques to extract key terms relevant to the topic;
comparing the extracted key terms to the plurality of topics and detailed content of individual topics included in the curriculum data;
identifying one or more topics in the curriculum data that closely matches to the topic details of the request data; and
ranking the one or more topics in the curriculum data such that a topic that closely matches to the topic details included in request data is ranked higher as compared to a less related topic.

19. The system of claim 13 wherein generating one or more questions related to the selected topic further comprises:
retrieving one or more questions generated in the past assessments that are relevant to the selected topic, wherein the past assessments along with the questions are stored in a memory coupled to the assessment generation system.

20. The system of claim 13 wherein receiving the assessment generation request from the assessment generation platform comprises:
providing a user interface to the user, on the assessment generation platform, to select:
a subject and at least one topic included in the subject; and
grade level of an end-user who will be taking the generated assessment;

21. The system of claim 13 wherein receiving the assessment generation request from the assessment generation platform comprises:
selecting the format including types of questions to be included in the assessment, wherein the types of questions include multiple choice questions, true or false, description questions, and fill in the blanks.

22. The system of claim 13 wherein the AI-based assessment generation system is configured to automate the delivery and grading of generated assessment in real-time.
